(19) United States
(12) Patent Application Publication
(10) Pub. No.: US 2003/0074657 A1
(43) Pub. Date: Apr. 17, 2003

(54) Limited time evaluation system for firmware

(76) Inventor: Richard A. Bramley JR., Mansfield, MA (US)

Correspondence Address: IRELL & MANELLA LLP, 840 NEWPORT CENTER DRIVE, SUITE 400, NEWPORT BEACH, CA, 92660, US

(21) Appl. No.: 09/976,993

(22) Filed: Oct. 12, 2001

(51) Int. Cl. G06F 9/44

(52) U.S. Cl. 717/168

(57) ABSTRACT

The invention relates to an apparatus and method for updating firmware. The method comprises reading at least a portion of the firmware from a first firmware storage device to a second firmware storage device. The firmware is updated by adding the firmware update to the portion of the firmware contained in the second firmware storage device so as to modify the firmware. The modified firmware is then written from the second firmware storage device back into the first storage device. Various embodiments are described.

### FIELD OF THE INVENTION

The present invention relates generally to computer systems having firmware, and in particular, relates to firmware which may be used for a limited time.

### BACKGROUND OF THE INVENTION

Currently, there is very little available to a user who wishes to perform a piecemeal evaluation of firmware. Firmware tends to be a monolithic structure because it has traditionally been supplied in a computing system, such as a personal computer (PC), within some type of read-only memory structure, e.g., a Read Only Memory (ROM). Because the read-only memory structure is commonly fixed at the time of manufacture, no additional features can be added without replacing the device which contains the firmware. Because of the fixed nature of firmware, it is difficult for those purchasing a system containing firmware to actually shop for the features within the firmware that they desire. For example, in a Basic Input/Output System (BIOS) contained within a personal computer, it is very difficult to give a user a generic BIOS and then allow them to try out different features. For example, a BIOS manufacturer would like to approach a computer manufacturer with a list of features and a price for additional features. The BIOS manufacturer would like also to permit the computer manufacturer to try out whatever features the manufacturer had selected for possible inclusion in their systems. As an additional example, if a computer manufacturer had purchased a BIOS system from a BIOS manufacturer and the BIOS manufacturer had developed a further feature, the most practical way to demonstrate that feature would be to bring an entirely new machine to the computer manufacturer. Because BIOS code is highly customized to individual machines it would be difficult to merely produce a generic BIOS which could have components added. On the other hand, BIOS manufacturers generally would like to be able to produce code for a new feature which could be added to the BIOS of multiple customers. In addition, it is desirable that even after a system is deployed that the BIOS manufacturer be able to sell additional features to customers having machines running versions of their BIOS. It would also be desirable to allow users contemplating additional features to be able to try out the features for a period of time before having to commit to a purchase.

### SUMMARY OF THE DISCLOSURE

The invention relates to an apparatus and method for updating firmware. The method comprises reading at least a portion of the firmware from a first firmware storage device to a second firmware storage device. The firmware is updated by adding the firmware update to the portion of the firmware contained in the second firmware storage device so as to modify the firmware. The modified firmware is then written from the second firmware storage device back into the first storage device. Various embodiments are described.

### BRIEF DESCRIPTION OF THE DRAWINGS

FIG. 1 is a system block diagram of a computer system which implements the embodiments of the invention.

FIG. 2 is a block diagram of one embodiment of a system provided in accordance with the principles of the invention.

FIG. 3 is one embodiment of a firmware feature table provided in accordance with the principles of the invention.

FIG. 4 is a flow diagram illustrating one embodiment of a time evaluation process provided in accordance with the principles of the invention.

FIG. 5 is a flow diagram illustrating one embodiment of a feature addition process provided in accordance with the principles of the invention.

FIG. 6 is a block diagram of a second embodiment of the system provided in accordance with the principles of the invention.

### DETAILED DESCRIPTION OF PREFERRED EMBODIMENTS

Firmware is generally considered to be software held within a hardware device within a system, which is generally not altered and provides system type utilities to the system. For example, in a personal computer the Basic Input/Output system or BIOS provides routines that may be accessed by application software or by the operating system. BIOS is also increasingly being implemented in flash type devices which allow the BIOS to be written when necessary, such as when the system changes or when the data changes. One aspect of the invention allows firmware routines to be tried by a user before purchasing. If the user does not wish to purchase the routines, the routines merely expire. To add such a limited-time routine to a firmware, the current firmware is read into a temporary storage memory. The added feature routine is then added to the temporary storage, the table of feature addresses (for example, see FIG. 3) is updated, and the previous firmware and the new routine is written back into the firmware storage area. When the try-before-you-buy routine is accessed, it checks to see if the time for using the routine has expired. If the routine has not yet expired, it simply performs the function as usual. As a result, firmware routines, whether in a PC BIOS or other firmware applications, can be examined or used for a limited period before a user commits to a purchase.

One embodiment of the present invention relates to a method of providing firmware code that may remain accessible for a period of time in order to facilitate use or testing of a particular feature. In one embodiment, the system involves a timer which allows a system to activate firmware code for a predetermined period.

In another embodiment, the firmware provided in accordance with the invention may be updated. The function of the updateable firmware may be implemented so as to be responsive to a predetermined timing or schedule.

Various embodiments of the present invention provide an updated firmware comprising a feature that is time dependent. The firmware may be implemented in a device, such as, but not limited to, rewritable non-volatile semiconductor memory. Such memories comprise a variety of technologies such as but not limited to flash memory, EEPROM (Electronically Erasable Programmable Read Only Memory), and FRAM (Ferro-electric Random Access Memory). In addition, the firmware may be implemented in a non-changeable memory, such as a ROM, and then loaded into random access memory (RAM) before use. The firmware, which has been loaded into the RAM can then be updated. In other embodiments, the firmware may be located in ROM, while the updates (such as new features) may be stored on another device, e.g., on a hard disk, etc.

In one embodiment, a time limitation is imposed upon the firmware. When the firmware containing a new feature is to be used, the time allocated for using the firmware is checked against the allowable timing for the feature. If the timing is within the time allotted to the firmware, then the feature functions normally. However, if the time allotted to the feature within the firmware has been exceeded, the feature will no longer function.

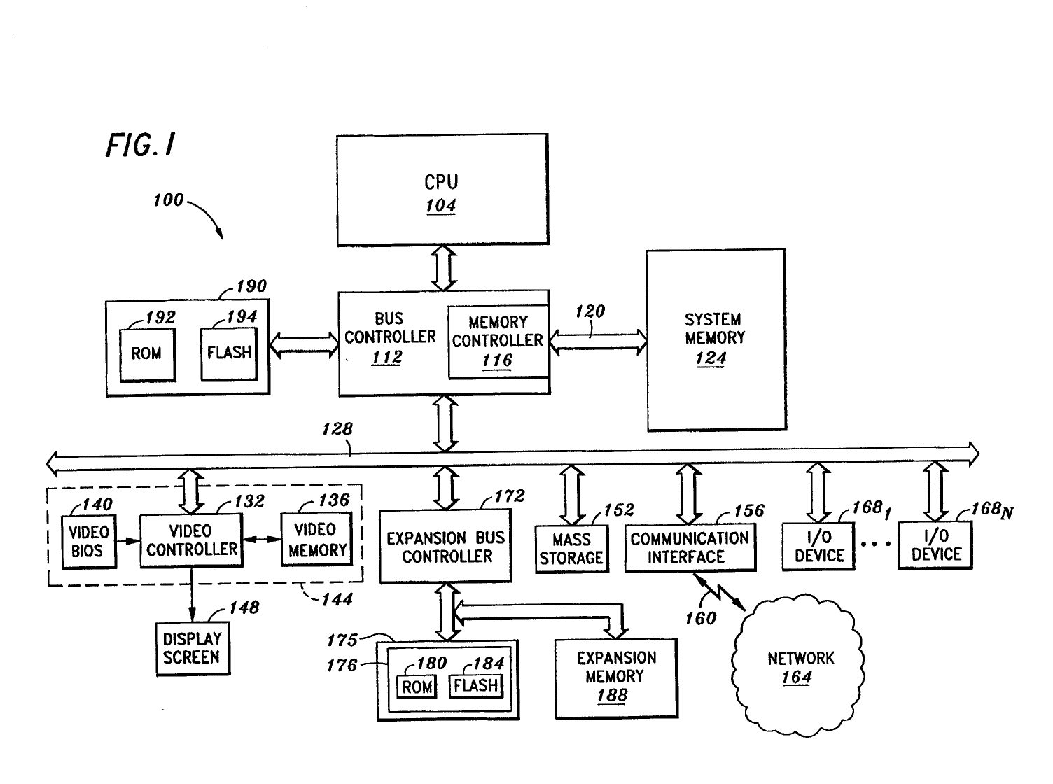

Referring to FIG. 1, the computer system 100 comprises a processor or a central processing unit (CPU) 104. The illustrated CPU 104 includes an Arithmetic Logic Unit (ALU) for performing computations, a collection of registers for temporary storage of data and instructions, and a control unit for controlling operation for the system 100. In one embodiment, the CPU 104 includes any one of the ×86, Pentium™, PentiumII™, Pentium PrO™, and Itanium™ microprocessors as marketed by Intel™ Corporation, the K-6 microprocessor as marketed by AMD™, or the 6×86MX microprocessor as marketed by Cyrix™ Corp. Further examples include the Alpha™ processor as marketed by Digital Equipment Corporationm, the 680X0 processor as marketed by Motorola™; or the Power PC™ processor as marketed by IBM™. In addition, any of a variety of other processors, including those from Sun Microsystems, MIPS, IBM, Motorola, NEC, Cyrix, AMD, Nexgen and others may be used for implementing CPU 104. The CPU 104 is not limited to microprocessor but may take on other forms such as microcontrollers, digital signal processors, reduced instruction set computers (RISC), application specific integrated circuits, and the like. Although shown with one CPU 104, computer system 100 may alternatively include multiple processing units. The CPU 104 is coupled to a bus controller 112. The bus controller 112 includes a memory controller 116 integrated therein, though the memory controller 116 may be external to the bus controller 112. The memory controller 116 provides an interface for access by the CPU 104 or other devices to system memory 124 via memory bus 120. In one embodiment, the system memory 124 includes synchronous dynamic random access memory (SDRAM). System memory 124 may optionally include any additional or alternative high speed memory device or memory circuitry. The bus controller 112 is coupled to a system bus 128 that may be a peripheral component interconnect (PCI) bus, Industry Standard Architecture (ISA) bus, etc. Coupled to the system bus 128 are a graphics controller, a graphics engine or a video controller 132, a mass storage device 152, a communication interface device 156, one or more input/output (I/O) devices 168₁-168_{N}, and an expansion bus controller 172. The video controller 132 is coupled to a video memory 136 (e.g., 8 Megabytes) and video BIOS 140, all of which may be integrated onto a single card or device, as designated by numeral 144. The video memory 136 is used to contain display data for displaying information on the display screen 148, and the video BIOS 140 includes code and video services for controlling the video controller 132. In another embodiment, the video controller 132 is coupled to the CPU 104 through an Advanced Graphics Port (AGP) bus.

The mass storage device 152 includes (but is not limited to) a hard disk, floppy disk, CD-ROM, DVD-ROM, tape, high density floppy, high capacity removable media, low capacity removable media, solid state memory device, etc., and combinations thereof. The mass storage device 152 may include any other mass storage medium. The communication interface device 156 includes a network card, a modem interface, etc. for accessing network 164 via communications link 160. The I/O devices 168₁-168_{N} include a keyboard, mouse, audio/sound card, printer, and the like. The I/O devices 168₁-168ₙ may be disk drive, such as a compact disk drive, a digital disk drive, a tape drive, a zip drive, a jazz drive, a digital video disk (DVD) drive, a magneto-optical disk drive, a high density floppy drive, a high capacity removable media drive, a low capacity media device, and/or any combination thereof. The expansion bus controller 172 is coupled to non-volatile memory 175, which includes system firmware 176. The system firmware 176 includes system BIOS 82, which is for controlling, among other things, hardware devices in the computer system 100. The system firmware 176 also includes ROM 180 and flash (or EEPROM) 184. The expansion bus controller 172 is also coupled to expansion memory 188 having RAM, ROM, and/or flash memory (not shown). The system 100 may additionally include a memory module 190 that is coupled to the bus controller 112. In one embodiment, the memory module 190 comprises a ROM 192 and flash (or EEPROM) 194.

As is familiar to those skilled in the art, the computer system 100 further includes an operating system (OS) and at least one application program, which in one embodiment, are loaded into system memory 124 from mass storage device 152 and launched after Power-On Self Test (POST). The OS may include any type of OS including, but not limited or restricted to, DOS, Windows™ (e.g., Windows 95™, Windows 98™, Windows NT™), Unix, Linux, OS/2, OS/9, Xenix, etc. The operating system is a set of one or more programs which control the computer system's operation and the allocation of resources. The application program is a set of one or more software programs that performs a task desired by the user.

In accordance with the practices of persons skilled in the art of computer programming, the present invention is described below with reference to symbolic representations of operations that are performed by computer system 100, unless indicated otherwise. Such operations are sometimes referred to as being computer-executed. It will be appreciated that operations that are symbolically represented include the manipulation by CPU 104 of electrical signals representing data bits and the maintenance of data bits at memory locations in system memory 124, as well as other processing of signals. The memory locations where data bits are maintained are physical locations that have particular electrical, magnetic, optical, or organic properties corresponding to the data bits.

When implemented in software, the elements of the present invention are essentially the code segments to perform the necessary tasks. The program or code segments can be stored in a processor readable medium or transmitted by a computer data signal embodied in a carrier wave over a transmission medium or communication link. The “processor readable medium” or “machine-readable medium” may include any medium that can store or transfer information. Examples of the processor readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, etc. The computer data signal may include any signal that can propagate over a transmission medium such as electronic network channels, optical fibers, air, electromagnetic, RF links, etc. The code segments may be downloaded via computer networks such as the Internet, Intranet, etc.

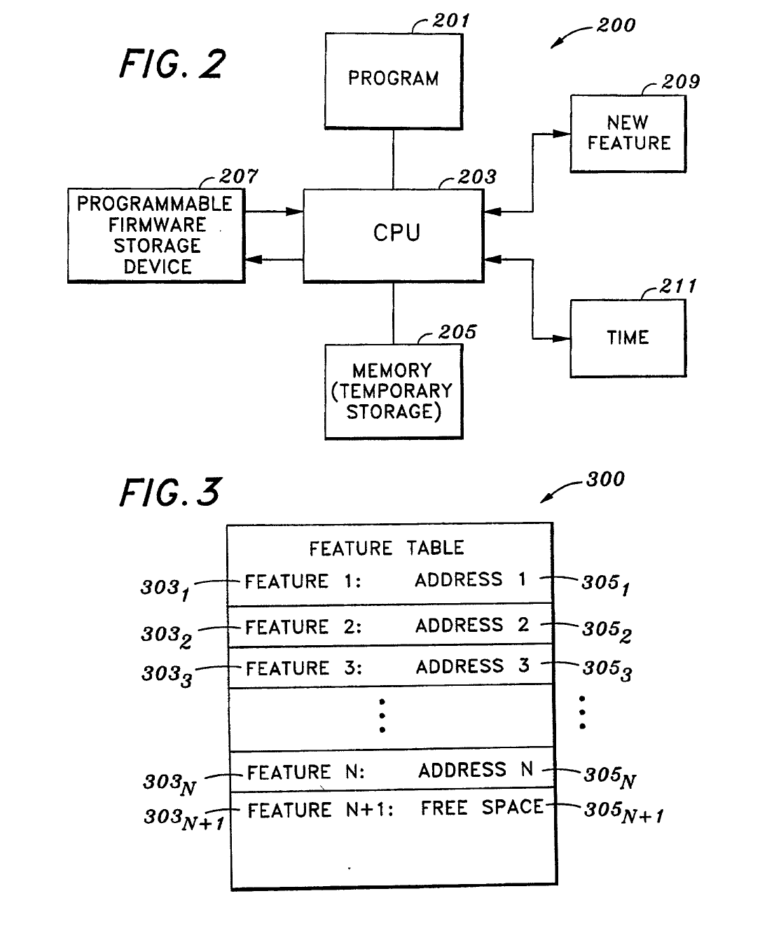

FIG. 2 is a block diagram of one embodiment of a system provided in accordance with the principles of the invention. The embodiment as shown in FIG. 2 may be used within the environment of FIG. 1. The embodiment of FIG. 2, however, is not specific to the environment illustrated in FIG. 1. The embodiment in FIG. 2 may be used with any system having firmware and the requisite other elements. In FIG. 2, the activity of a central processing unit (CPU) 203 is directed by a program 201. The program 201 may be stored in memory, such as memory 124, 152, 175, 190 of FIG. 1, or memory provided by any means known in the art. In one embodiment, the program 201 is stored in memory 124. The CPU 203 is coupled to a programmable firmware storage device 207. Such a programmable firmware storage device 207 may take a variety of forms well known in the art. For example, the programmable firmware storage device 207 may comprise, but is not limited to, a flash memory, a non-volatile RAM memory (NVRM), and electrically erasable programmable read-only memory (EEPROM), a ferro-electric random access memory (FRAM) or a variety of other programmable devices.

Under direction of the program 201, the CPU 203 reads the firmware from the programmable firmware storage device 207 and stores the firmware from the programmable storage device 207 into a temporary storage memory 205. In one embodiment, the temporary storage memory 205 is a Random Access Memory (RAM). However, any other type of storage may be used as the temporary memory storage 205. For example, a hard disk, floppy disk, or read/writable CD ROM may be used. Once the CPU 203 has read the firmware into the memory 205, the CPU 203 determines at what point the code comprising the firmware (within the programmable firmware storage device 207) ends. The CPU 203, under direction from program 201, can then determine at which point the new feature 209 can be added to the firmware which has been temporarily stored in memory 205. Next, the CPU 203 adds the new feature 209 to the firmware (which has been written into memory 205). The CPU 203 then takes the content of memory 205, including both the firmware and the new feature, and writes it back into the programmable storage device 207.

When the time has come to use the new feature, the CPU 203 may access the new feature (which is contained in the programmable storage device 207). Additionally, the CPU 203 may read the entire firmware from the programmable storage device 207 into the temporary memory device 205. For example, this may be performed in the case of a shadow RAM, which reads the firmware from a system into a faster random access memory, such as 205. Once the CPU 203 accesses the feature within the firmware, a time check is made as part of the programming of the feature. For example, the feature may have encoded a certain time and date indicating when the feature is to expire. The CPU 203 can then check the expiration time and date against the actual (current) time 211 such as from a real time clock or localized time clock within the system, an internet connection having a time facility or the like. If the feature is within the limits of the tryout period, then the feature executes and performs normally. If the feature is past the time period, then the feature is skipped over and in some embodiments, a user message may be displayed. The instructions that cause the CPU 203 to read the expiration time and date may be located either within the feature or in memory, such as system memory 124. When the expiration time and date is located within the feature, it provides greater security to the system.

Instead of using a strict calendar date and time to ascertain the expiration of the new feature 209 (which has been added to the firmware on a trial device), other types of timing may be employed. For example, instead of using a mere calendar date, the feature may expire a number of hours after it has been installed. In such a case, the CPU 203 may read the time from a real time clock 211, a local time clock (not shown) or other such device, into the new feature when it is being installed. In this case, once a predetermined time period or interval has elapsed, the feature expires. Additionally, the CPU 203 or the feature may be set to count the number of times the feature has been used, or the number of times the system has booted up. The feature may be set to expire after it has been used a predetermined number of times or after the system in which it resides has been booted a number of times. In either case, the CPU 203 or the feature can determine if subsequent attempts to execute or use the feature is still within the allotted tryout time. If not within the allotted tryout time, the feature will be skipped over and the user may be prompted with a message that the feature has expired.

FIG. 3 is one embodiment of a firmware feature table provided in accordance with the principles of the invention. The features within the firmware may be listed within some firmware system, such as within the BIOS system of a personal computer. In one embodiment, the feature table 301 may contain a plurality of features 303₁ to 303_{N} and addresses 305₁ to 305_{N}. Corresponding to each feature, e.g., feature 303₁, is an address, such as address 305₁. For example, a first feature 303₁ and an address 305₁ at which the feature might be found within the firmware. In like manner, the addresses of end features could be identified within the feature table. The N+1st address 305_{N+1} would be followed by free space 305_{N+1}. The free space would be designated by a marker such as an address outside of the firmware address range or a repeating data pattern. When a new feature is added to the firmware, it will be added to the feature table at 303_{N+1} and the address will be entered at 305_{N+1}. In this way, one or more features and their corresponding address(es) may be added to the feature table.

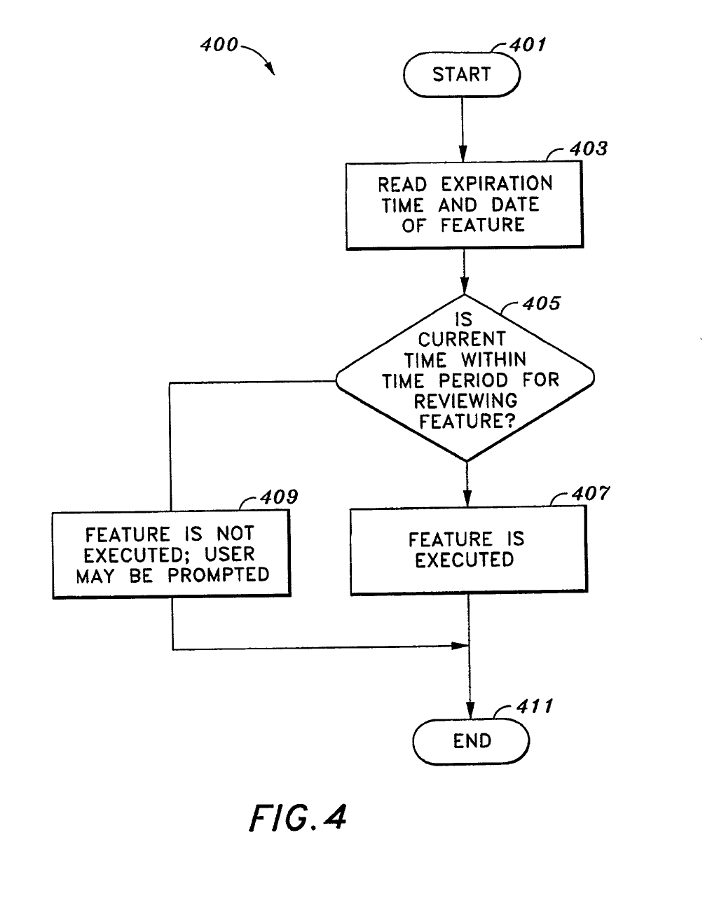

FIG. 4 is a flow diagram illustrating one embodiment of a time evaluation process 400 provided in accordance with the principles of the invention. Proceeding from a START state, as shown in process block 401 the feature is accessed, or called by the CPU 203. When the feature begins to execute, the CPU 203, under the instructions stored either in the feature or memory 124, will read the expiration time and date as depicted in process block 403. Next, the process 400 determines if the current or actual time is still within the time period for reviewing the feature, or within the tryout time limit. That is, the CPU 203 determines if the current time has exceeded the expiration time and date for reviewing the feature. If the time is within the feature review or tryout time limit, the feature will be executed, as shown in process block 407. If the time period for reviewing the feature has expired, the feature is not executed and the user may be prompted that the time period for reviewing the feature has expired 409. The routine terminates in process block 411 after either executing the feature or skipping over the feature.

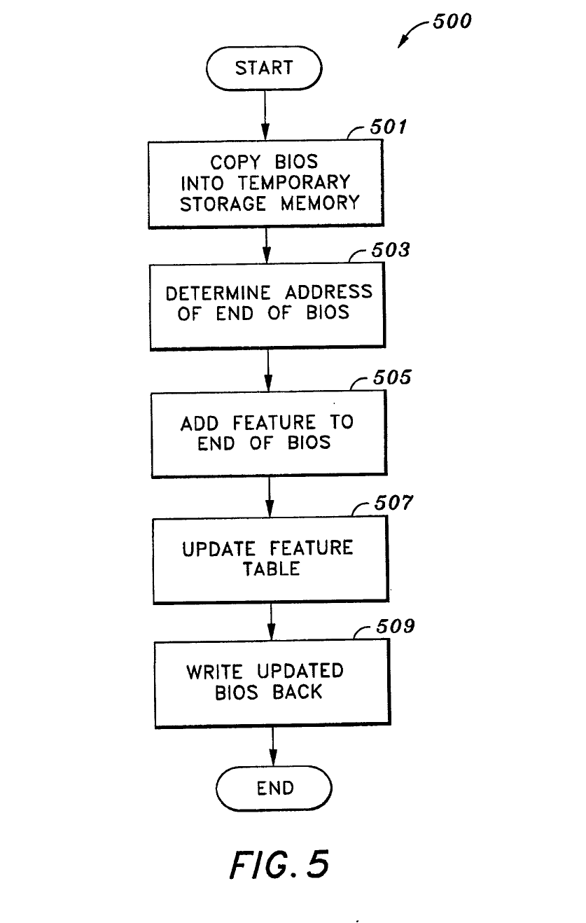

FIG. 5 is a flow diagram illustrating one embodiment of a feature addition process provided in accordance with the principles of the invention. For purposes of illustration, it is assumed that the time-dependent firmware feature of the present discussion is being installed into a personal computer (PC) system. In this environment, the time-dependent feature is being added to the firmware BIOS of a PC system. Although this example is used for discussion purposes, the process 500 may be implemented and/or applied to any other firmware system. The installation process 500 proceeds from a START state when the routine or process 500 is called. At process block 501, the BIOS firmware or code is copied into a temporary storage memory (such as memory 205 of FIG. 2). Next, the address of the end of the BIOS code is determined, as shown in process block 503. In one embodiment, the end of the BIOS firmware or code is marked by some type of marker such as a repeated idle instruction. Once the address of the end of the BIOS code has been located, the time-dependent feature, along with corresponding code for checking the time-dependency, can be added to the end of the BIOS code (process block 505). In one embodiment, a second marker marking the end of the BIOS firmware (including the new feature and corresponding time-dependency checking code) can then be written/placed at the end of the code representing the global time-dependent feature and time-dependency checking code. The feature table within the BIOS can then be updated as illustrated in process block 505. The updated BIOS including the new feature, the time testing code within the new feature and the new feature table can be then written back into the area where the original BIOS had been resident. This action is illustrated in process block 509. Once the updated BIOS has been written back into the rewritable storage area, the process 500 terminates.

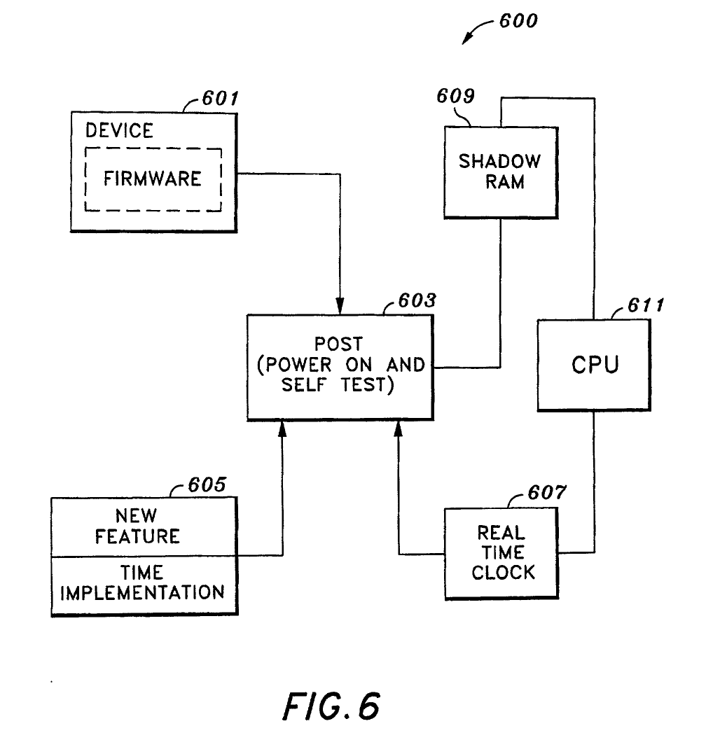

FIG. 6 is a block diagram of a second embodiment of the system provided in accordance with the principles of the invention. In FIG. 6, the firmware resides within a device 601, which may or may not be rewritable. Such devices may be ROM, flash, or RAM. A power-on self-test (POST) routine, which typically occurs at the beginning of a boot-up sequence can be configured to fetch the firmware from device 601 and write the firmware into a shadow RAM 609. The new feature and time information corresponding to the new feature 605 can then be accessed by the power-on portion of the POST routine. The new feature and the corresponding time verification code can then be appended to the current firmware in the shadow RAM 609. Once the new feature and firmware has been installed in shadow RAM 609, the system 5 may proceed normally and may access the firmware from the shadow RAM 609.

When the system is running, a CPU 611 may access the firmware and the new feature from shadow RAM 609. If the new feature is accessed from the shadow RAM 609, it will contain code that will check to see if the feature has timed out or should still remain active. One way in which the feature may check to see if the firmware has timed out is to access a real time clock 607 which may be contained in the system. If the feature is one which expires at a particular real time, then comparing the expiration time with the real time clock will determine if the feature is still active. In addition, other mechanisms such as counting the number of boot-ups to determine the expiration time of the feature, counting an elapsed time, or counting the number of used of the feature might be used in order to determine whether or not the feature is still active. If the feature is still active, it may be accessed normally. If the feature is no longer active, then a user may be prompted that the feature has expired.

The foregoing descriptions of exemplary embodiments of the present disclosure have been presented for the purpose of illustration and description. It is not intended to be exhaustive nor to limit the inventive concepts to the embodiments disclosed. Many modifications and variations are possible in light of the above teaching. It is intended that the scope of the invention be limited not within this detailed description, but rather by the claims appended hereto, which appear below.

What is claimed is:

1. An apparatus for updating a firmware, comprising:
a first firmware storage device to store the firmware;
a computing unit to perform an update process,
a program used by the computing unit to perform the update process;
a second firmware storage device to temporarily store at least a portion of the firmware received from the first firmware storage device,
wherein the computer unit utilizes the program to
a. read out at least a portion of the firmware from the first firmware storage device to the second firmware storage device,
b. update the firmware by adding the firmware update to the portion of the firmware contained in the second firmware storage device so as to modify the firmware, and
c. write the modified firmware from the second firmware storage device back into the first storage device.

2. An apparatus as recited in claim 1, wherein:
the first firmware storage device comprises a writable non-volatile memory.

3. An apparatus as recited in claim 1, wherein:
the second firmware storage device comprises at least one of a hard disk, a floppy disk, a random access memory, a magnetic tape, a magnetic storage device, and an optical disk.

4. An apparatus as recited in claim 1, wherein:
the computing unit comprises at least one of a microprocessor, a digital signal processor, a distributed processor network, a processor connected through the Internet.

5. An apparatus as recited in claim 1, wherein:
the modified firmware includes a portion that comprises code that determines if the feature has expired.

6. An apparatus as recited in claim 5, wherein the code causes the computing unit to:
provide for a limited time availability for at least a portion of the updated firmware,
determine a present time,
determine the availability of at least a portion of the updated firmware by comparing the present time to the limited time availability,
terminate availability of at least a portion of the updated firmware when the present time is greater than the limited time availability.

7. An apparatus as recited in claim 6, wherein:
determining of the availability of at least a portion of the updated firmware by comparing the present time to the limited time ability comprises:
reading the present time from a clock from a predetermined source, and
comparing the present time to the limited time availability expressed as a real time.

8. An apparatus as recited in claim 7, wherein the predetermined source is a real time source.

9. An apparatus as recited in claim 7, wherein the predetermined source is an internet time source.

10. An apparatus as recited in claim 6, wherein
determining of the availability of at least a portion of the updated firmware by comparing the present time to the limited time ability comprises:
reading the present time from an elapsed time counter, and
comparing the present time to the limited time availability expressed as a total elapsed time.

11. An apparatus as recited in claim 6, wherein
determining of the availability of at least a portion of the updated firmware by comparing the present time to the limited time ability further comprises:
reading the present time from a number of uses counter which counts the number of times a portion of the firmware is used, and
comparing the present time to the limited time availability expressed as a total number of uses.

12. An apparatus as recited in claim 6, wherein
determining of the availability of at least a portion of the updated firmware by comparing the present time to the limited time ability further comprises:
reading the present time from a counter which counts the number of times that a system containing the firmware has been booted since the firmware was updated, and
comparing the present time to the limited time availability expressed as a total number of times that the system has booted since the firmware was updated.

13. A method for updating a first firmware, comprising:
reading the first firmware,
merging at least a portion of the first firmware with a second firmware to form an updated firmware,
writing at least a portion of the updated firmware back to the location from which the first firmware was read.

14. A method as in claim 13 wherein merging at least a portion of the first firmware with a second firmware to form an updated firmware comprises:
locating a final element of code within the first firmware,
storing a portion of the second firmware within the first of firmware to form an updated firmware.

15. A method as in claim 14 further comprising:
locating a feature table within the firmware,
wherein said feature table lists the addresses and functions of code within the firmware,
adding an address and function corresponding to at least one feature from the second firmware to the function table.

16. A method as in claim 15 wherein the first firmware comprises a basic input/output system (BIOS).

17. A method for updating firmware, the method comprising:
reading the firmware to be updated,
placing the firmware in a shadow RAM,
reading a new feature and timing information corresponding to the new feature,
determining if the new feature has expired, and
writing the new feature into shadow RAM if it has not expired.

18. A method as in claim 17 wherein reading a new feature and timing information corresponding to the new feature further comprises:
reading data corresponding to the new feature and timing information, and
decompressing the data corresponding to the new feature and timing information.

19. A method as in claim 17 wherein reading a new feature and timing information corresponding to the new feature further comprises,
reading data corresponding to the new feature and timing information, and
decrypting the data corresponding to the new feature and timing information.

20. A method as in claim 17, wherein determining if the new feature has expired comprises:
reading the present time from a real time clock, and
comparing the present time to the limited time availability expressed as a real time.

21. A method as in claim 17, wherein determining if the new feature has expired comprises:
reading the present time from an elapsed time counter, and comparing the present time to the limited time availability expressed as a total elapsed time.

22. A method as in claim 17, wherein determining if the new feature has expired comprises:
reading the present time from a number of uses counter which counts the number of times a portion of the firmware is used; and
comparing the present time to the limited time availability expressed as a total number of uses.

23. A method as in claim 17, wherein determining if the new feature has expired comprises:
reading the present time from a counter which counts the number of times that a system continuing the firmware has been booted since the firmware was updated; and
comparing the present time to the limited time availability expressed as a total number of times that the system has booted since the firmware was updated.
